(19) United States
(12) Patent Application Publication
(10) Pub. No.: US 2004/0058206 A1
(43) Pub. Date: Mar. 25, 2004

(54) Method for improving the water balance of fuel cells

(76) Inventors: Erich Erdle, Immenstaad (DE); Alfred Koch, Meersburg (DE); Gerhard Konrad, Ulm (DE); Ottmar Schmid, Markdorf (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/470,367

(22) PCT Filed: Jan. 16, 2002
(86) PCT No.: PCT/EP02/00360

(30) Foreign Application Priority Data
Jan. 26, 2001 (DE) 101 03 568.3

(51) Int. Cl. H01M 8/04; H01M 8/10

(52) U.S. Cl. 429/13; 429/26; 429/32

(57) ABSTRACT

The invention relates to a method for improving the water balance of an electrochemical cell stack, comprising:—a membrane electrode assembly (MEA) consisting of an anode, a cathode and an electrolyte arranged therebetween;—an anode gas chamber for distributing the anode gas to the membrane electrode assembly, said anode gas containing hydrogen and being de-humidified or partially humidified;—a cathode gas chamber for distributing the cathode gas to the membrane electrode assembly, said cathode gas containing oxygen;—a cooling chamber for distributing a coolant for cooling the cell stack, said cooling chamber being separated from the cathode gas chamber (3) by a porous separation plate (6). According to the invention, water is exchanged between the cathode gas and the coolant through the porous separation plate (6), located between the cathode gas chamber (3) and the cooling chamber (4), by means of an aqueous coolant, which has a lower temperature-dependent water-vapour partial pressure in relation to water.

The invention relates to a method for improving the water balance in fuel cells, in particular low-pressure fuel cells.

Fuel cells are electrochemical units which generate electrical energy by conversion of chemical energy at catalytic surfaces of electrodes.

Electrochemical cells of this type comprise the following main components:

a cathode electrode at which the reduction reaction takes place by addition of electrons. The cathode comprises at least one electrode support layer which serves as a support for the catalyst,

an anode electrode, at which the oxidation reaction takes place through release of electrons. The anode, like the cathode, comprises at least one support layer and catalyst layer,

at least one matrix which is arranged between cathode and anode and serves as support for the electrolyte. The electrolyte may be in solid or liquid phase and in the form of a gel. The electrolyte is advantageously incorporated in solid phase in a matrix, so that what is known as a solid electrolyte is formed,

at least one separator plate, which is arranged between the MEAs and is used to collect reactant and oxidant in electrochemical cells,

anode gas chambers which are arranged between the anode-side separator plate and the MEA and through which the anode gas flows,

cathode gas chambers which are arranged between the cathode-side separator plate and the MEA and through which the cathode gas flows,

cooling chambers through which a cooling medium flows and which are used to cool the cells,

sealing elements which both prevent the fluids from mixing in the electrochemical cells and prevent the fluids from emerging from the cell to the surrounding area,

collection and distribution passages for supplying and discharging the starting materials or products and the cooling media.

The first three components of the above list are also referred to as the membrane electrode assembly (MEA), the cathode electrode being applied to one side of the matrix and the anode electrode to the other side.

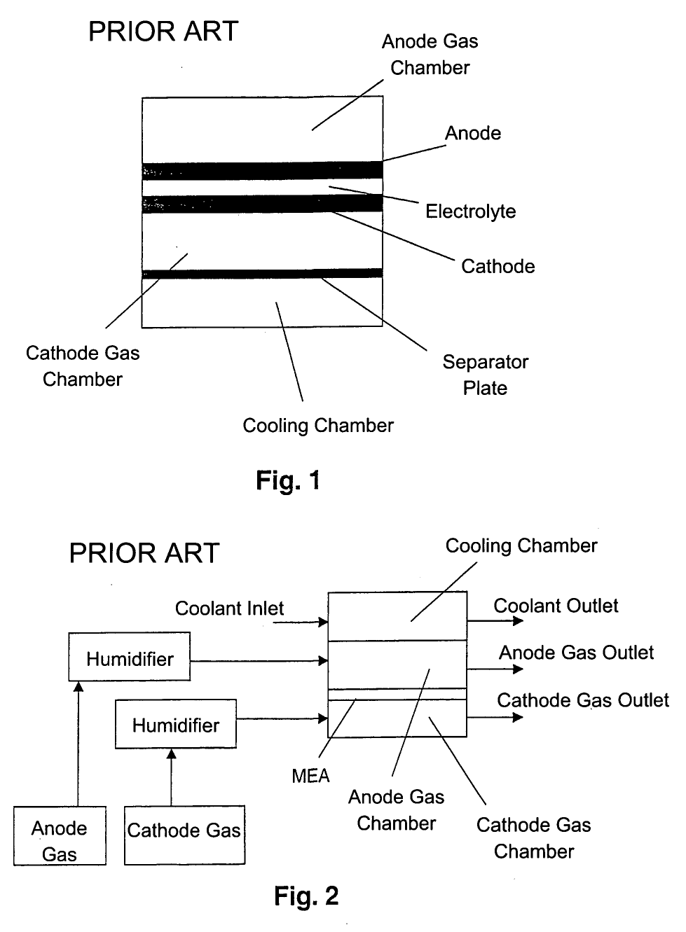

If fuel cells are stacked on top of one another, a fuel cell stack is formed, also referred to below as just a stack for short. FIG. 1 illustrates, by way of example, the structure of a fuel cell in accordance with the prior art. The anode gas chamber is in this case separated from the cathode gas chamber by the membrane electrode assembly, comprising an anode, a cathode and an electrolyte. To cool the cell there is a cooling chamber through which a cooling medium flows.

The electric current runs in a series circuit from cell to cell. The fluid management of the oxidant and reactant takes place via collection and distribution passages leading to the individual cells connected in parallel.

In fuel cells based on hydrogen and oxygen, the overall reaction takes place in accordance with the following equation

H₂+½O₂->H₂O+process heat+electric current.

Excess reactant and oxidant fluid is guided out of the cells. Furthermore, to maintain the efficiency of the electrochemical reaction, the product water has to be discharged from the cell. This should not adversely affect the state of the electrolyte.

In the case of aqueous electrolytes, the electrolyte resistance is highly dependent on the water content of the electrolyte. To achieve the lowest possible voltage drop across the cell, the electrolyte resistance should be minimized when the cell is operating. To satisfy this requirement, it is desirable to achieve homogeneous removal of the product water.

The product water is usually removed by means of the water vapor loading of the reaction gases. If the reaction gases are supersaturated, the liquid water is also forced out of the gas chambers of the cells by means of the dynamic pressure of the reaction gases.

The discharge of product water across the cell area is usually evened out by the dry reaction gases being prehumidified before they enter the cell. This prehumidification prevents the electrolyte from drying out in the gas inlet region of the cell. The electrolyte drying out would cause the cell to fail.

The exemplary structure of a fuel cell system with separate prehumidification of the reaction gases is illustrated in FIG. 2. In this case, the anode gas and the cathode gas are in each case prehumidified in a humidifier before entering the fuel cell.

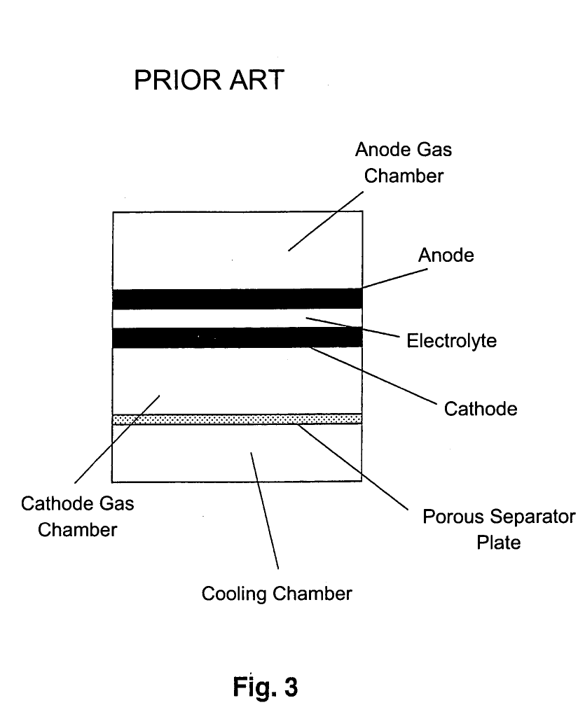

H₂O separation via a porous layer present at the cathode chamber is also known. An exemplary embodiment is illustrated in FIG. 3. In this arrangement, the cooling chamber and the cathode chamber are arranged adjacent to one another separated by the porous layer, e.g. a porous separator plate. Water usually flows through the cooling chamber. On account of the diffusion through the porous separator plate, this arrangement firstly makes it possible to humidify the cathode gas in the cell inlet region. Secondly, the liquid water in the supersaturated area of the cell is transported out of the cathode gas chamber through the porous layer.

This arrangement partially compensates for the water loading over the cell area and therefore also homogenizes the water content in the electrolyte, a high water vapor partial pressure difference between cathode gas inlet and outlet being present despite these measures. The desired minimal electrolyte resistance in such cells is only achieved in partial regions of the cell area. In this case too, an additional, separate anode gas humidification step is required. The water for this is usually obtained from the cathode gas. One drawback is that this embodiment cannot be used at temperatures below 0° C. without providing the cooling medium water with antifreeze measures. Moreover, additional water, e.g. from separate water tanks, has to be fed to the cooling circuit at an operating temperature above 65° C., which is undesirable in particular in mobile applications. Then, at operating temperatures of over 65° C., more water is discharged via the fuel cell outgoing air than is generated by the fuel cell process.

It is an object of the invention to provide a method which, without apparatus measures or outlay, makes it possible to achieve a homogeneous electrolyte state over the entire area of the fuel cell within a wide temperature range.

The object is achieved by the subject matter of patent claim 1. Advantageous embodiments form the subject matter of subclaims.

According to the invention, an exchange of water between the cathode gas and the cooling medium is realized using an aqueous cooling medium, which has a temperature-dependent water vapor partial pressure which is lower than water, via the porous separator plate arranged between cathode gas chamber and cooling chamber. In the inlet region of the fuel cell, the water vapor partial pressure difference between the cooling medium in the cooling chamber and the dry cathode gas in the cathode gas space means that water is transported from the cooling medium toward the cathode gas through the porous separator plate. This leads to humidification of the dry cathode gas. In the remaining part of the cell, product water is formed in the cathode gas chamber on account of the fuel cell reaction, with the result that the water vapor partial pressure in the cathode gas increases. If the water vapor partial pressure of the cathode gas exceeds the water vapor partial pressure of the cooling medium, water is transported from the cathode gas toward the cooling medium through the porous separator plate. Consequently, a substantially homogeneous electrolyte state is therefore established over the entire cell area.

Moreover, the method according to the invention is responsible for supplying moisture to and removing moisture from the electrolyte in a cell area.

To further homogenize the water content of the electrode, it is also possible for a porous separator plate with the function described above to be arranged on the anode side.

A further advantage is that a homogeneous electrolyte state can also be achieved for temperatures above 65° C. without additional measures, e.g. a water tank, being required.

If the cooling medium is selected appropriately, it is possible to achieve an even water balance within the cell. The mass flow of the dehumidification—product water is transported from the cathode gas chamber toward the cooling chamber—dominates the mass flow of humidification—water is transported from the cooling chamber toward the cathode gas chamber in order to humidify the cathode gas. This leads to a rise in the water content in the cooling medium. Therefore, an equilibrium between the water vapor partial pressure in the cathode gas and the water vapor partial pressure in the cooling medium is established for a certain fuel cell operating temperature.

Inorganic solutions, e.g. buffer solutions, or organic solutions, e.g. glycols, glycerol or salts of organic acids, can advantageously be used as cooling medium. Furthermore, the cooling medium may be a non-corrosive aqueous solution, emulsion or suspension. These solutions have a lower temperature-dependent water vapor partial pressure than pure water. This allows the method according to the invention to be used without additional antifreeze measures at temperatures below 0°C.

In an advantageous embodiment, the surface of the separator plate which faces the cathode gas space may be hydrophilic and the surface which faces the cooling chamber may be hydrophobic. This prevents the cooling medium from passing from the cooling chamber into the cathode gas space through the pores in the separator plate. A further result is that the product water formed in the cathode gas space can be transported into the cooling chamber through the pores.

However, the transport of water between the cooling chamber and the cathode gas chamber can also be influenced by the liquid level in the porous separator plate or by the mass transfer path length of the water vapor in the porous separator plate, which can be set by means of the pressure within the cooling chamber and/or cathode gas chamber.

A further possible way of influencing the transport of water between the cooling chamber and the cathode gas chamber consists in the form of the pore diameter. This makes it possible to adjust the equilibrium between water vapor partial pressure of the cathode gas and the water vapor partial pressure of the cooling medium. The water vapor partial pressure in the pores is set approximately according to the following equation:

$$\frac{{p}_{D}}{{p}_{D}^{*}} = exp ( \frac{- 2 \underline{Q}}{r \cdot {q}_{F} \cdot {R}_{D} \cdot T} )$$

where

Q is the surface tension

R is the pore radius

p_{D} is the water vapor pressure in the pore

p_{D}* is the saturation vapor pressure in the pore

q_{F} is the density of the cooling medium

T is the temperature of the cooling medium

R_{D} is a special gas constant of water vapor

In an advantageous embodiment of the invention, there is a membrane separator with a membrane for humidifying the anode gas. In the membrane separator, the cooling medium is passed along one side of the membrane and the dry anode gas is passed along the other side of the membrane. On account of the water vapor partial pressure difference between the two media, water is transported from the cooling medium to the anode gas, so that the latter is humidified. Consequently, the product water which has been taken up by the cooling medium within the fuel cell is used to humidify the anode gas by means of the membrane separator. There is therefore no need for separate humidification of the anode gas.

In a further advantageous embodiment of the invention, the cooling chambers of the electrochemical cell stack, the membrane separator and a metering device for metering the cooling medium are connected into a circuit for the cooling medium. This ensures a continuous supply of cooling medium to the fuel cell stack. The metering device advantageously ensures that only a certain proportion of the cooling medium which emerges from the fuel cell stack is fed to the membrane separator. This allows defined setting of the humidification of the dry anode gas.

There is advantageously a further circuit for the anode gas, into which the electrochemical fuel cell stack and the membrane separator are connected. Consequently, anode gas which has not been consumed in the fuel cell stack can be reused by being fed from the fuel cell stack to the membrane separator.

However, it is also possible for the anode gas to be metered to the fuel cell stack in sufficient quantity for there to be no excess anode gas downstream of the fuel cell stack. This makes it possible to dispense with the need to return the anode gas from the fuel cell stack to the membrane separator.

Further advantageous embodiments of the inventions are explained in more detail below with reference to drawings, in which:

FIG. 1 shows a structure of a fuel cell in accordance with the prior art, as explained in the introduction to the description,

FIG. 2 shows a structure of a fuel cell with porous separator plate in accordance with the prior art, as explained in the introduction to the description,

FIG. 3 shows a structure of a fuel cell system with separate prehumidification of the anode gas and cathode gas in accordance with the prior art, as explained in the introduction to the description,

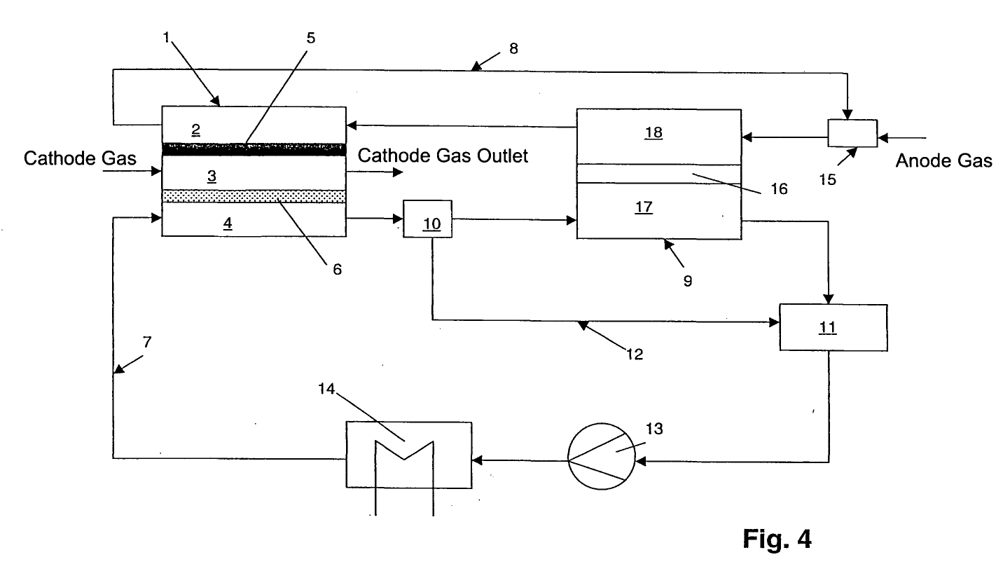

FIG. 4 shows a structure of a fuel cell system in accordance with the invention with a membrane separator for humidification of the anode gas,

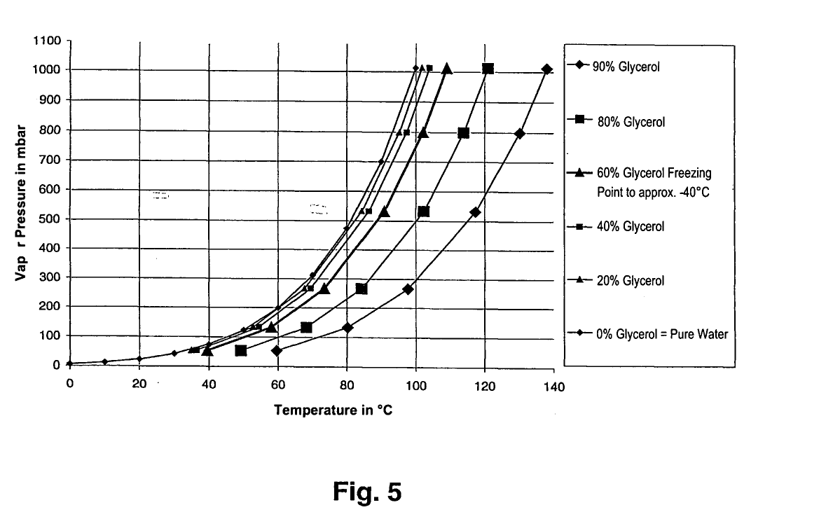

FIG. 5 shows a comparison between the vapor pressure curves of various mixing ratios of a glycerol-water solution,

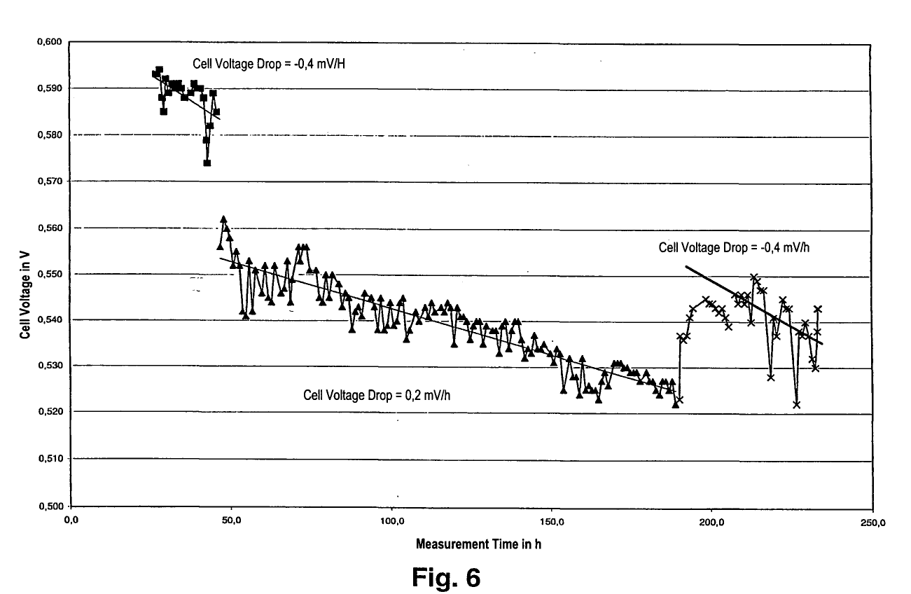

FIG. 6 shows the voltage curve of a fuel cell with a glycerol-water solution as cooling medium.

FIG. 4 shows a structure of a fuel cell system in accordance with the invention. The cooling chamber 4 of the fuel cell stack 1, a metering valve 10 and a water separator 9 (e.g. a membrane separator) for water separation are connected to a circuit 7 for the cooling medium. The membrane separator 9 comprises two chambers 17, 18 separated by a membrane 16. The membrane 16 is used to enable the water contained in the cooling medium to pass from the chamber 17 into the chamber 18. This results in humidification of the anode gas flowing through the chamber 18.

The metering valve 10 is connected between the fuel cell stack 1 and the membrane separator 9. Therefore, after it has passed through the cooling chamber 4 of the fuel cell stack 1, the cooling medium passes through the metering valve 10 into the chamber 17 of the membrane separator 9, where the water which is present in the cooling medium is separated off.

A compensation vessel 11 is advantageously connected downstream of the membrane separator 9. This compensation vessel 11 is used to compensate for volume fluctuations in the cooling medium caused by the water content which varies as a function of the temperature (operating temperature of the fuel cell).

A connection 12 is formed between the metering valve 10 and the compensation vessel 11, so that it is possible for only a partial stream of the cooling medium which emerges from the fuel cell stack 1 to be passed into the membrane separator 9.

A heat exchanger 14 connected upstream of the fuel cell stack 1 ensures that the cooling medium is brought to the appropriate operating temperature of the fuel cell stack 1. The cooling medium is transported from the membrane separator 9 through the heat exchanger 14 into the cooling chamber 4 of the fuel cell stack 1 by means of a pump 13 connected into the circuit 7. In the fuel cell stack 1, the cooling chamber 4 is separated from the cathode gas chamber 3 by means of a porous separator plate 6, resulting in exchange of water between the chambers.

The anode gas chamber 2 of the fuel cell stack 1 and the chamber 18 of the membrane separator 9 are connected into a further circuit 8. The chamber 18 of the membrane separator 9 is arranged upstream—as seen in the direction of flow of the anode gas—of the anode gas chamber 2 of the fuel cell stack 1. It is therefore possible for unused anode gas from the fuel cell stack 1 to be reused. A metering device 15 (e.g. a propulsive jet pump) connected upstream of the membrane separator 9 makes it possible to add fresh, unused anode gas to the circuit 8. In advantageous embodiments in which the anode gas is not completely consumed in the fuel cell, it is possible to dispense with having to recycle the anode gas by means of the circuit 8.

The flow guidance of the fluids in the fuel cell can be selected substantially in any desired way. An example of the flow guidance is illustrated in FIG. 4. In this case, the cathode gas flows in countercurrent with respect to the anode gas and in cocurrent with respect to the cooling medium.

FIG. 5 illustrates the vapor pressure curves for various mixing ratios of a glycerol-water solution. In this case, the vapor pressure is plotted against the temperature. As the glycerol concentration increases, the vapor pressure of the solution drops. At a temperature of 80° C., the vapor pressure for pure water is approx. 474 mbar. At a glycerol concentration of 60%, the vapor pressure drops to approx. 370 mbar. A glycerol-water solution with a glycerol concentration of 90% has a vapor pressure of approx. 130 mbar. A greater concentration of glycerol in the glycerol-water solution reduces the freezing point of the solution. For example, the freezing point of a glycerol-water solution with a glycerol concentration of 63% is approx. −40° C. A solution of this type can therefore be used as cooling medium in the method according to the invention without the need for any additional antifreeze measures.

The voltage curve of a fuel cell is illustrated in FIG. 6. This shows the results of a long-term test with the cell voltage plotted against the measurement time. The test was carried out at a cell temperature of 70° C. and a current density of 0.5 A/cm². The left-hand curve in the diagram shows the curve of the cell voltage with pure water used as cooling medium. The cell voltage drops at 0.4 mV/h, and furthermore a considerable fluctuation range in the cell voltage is apparent. The middle curve in the diagram shows the voltage curve of a fuel cell in which a glycerol-water solution with a glycerol concentration of 60% was used as cooling medium. The voltage fluctuations over the course of time have been considerably reduced in this experiment. This can be attributed to the fact that an electrolyte state which was homogeneous over the entire cell area was created. Moreover, a lower drop in the cell voltage, at 0.2 mV/h, was observed than in the experiment using pure water as cooling medium.

The right-hand curve once again shows the voltage curve of the fuel cell with pure water used as cooling medium. This once again shows a considerable fluctuation in the cell voltage and a greater voltage drop of 0.4 mV/h.

1. A method for improving the water balance in an electrochemical cell stack which comprises:
a membrane electrode assembly (MEA) made up of an anode, a cathode and a electrolyte arranged between them,
an anode gas chamber for distributing an anode gas to the membrane electrode assembly, the anode gas containing hydrogen and being unhumidified or partially humidified,
a cathode gas chamber (3) for distributing a cathode gas to the membrane electrode assembly, the cathode gas containing oxygen,
a cooling chamber for distributing a cooling medium in order to cool the cell stack, the cooling chamber and the cathode gas chamber (3) being separated by a porous separator plate (6),
characterized in that an exchange of water between the cathode gas and the cooling medium is realized using an aqueous cooling medium, which has a temperature-dependent water vapor partial pressure which is lower than water, via the porous separator plate (6) arranged between cathode gas chamber (3) and cooling chamber (4).

2. The method as claimed in claim 1, characterized in that the porous separator plate (6) arranged between cathode gas chamber (3) and cooling chamber (4) has a hydrophilic surface on the cathode side and a hydrophobic surface facing the cooling chamber.

3. The method as claimed in one of the preceding claims, characterized in that inorganic solutions, such as buffer solutions, or organic solutions, such as glycols or salts of organic acids, are used as cooling medium.

4. The method as claimed in one of the preceding claims, characterized in that the exchange of water between the cathode gas chamber and the cooling chamber is set by means of the diameter of the pores of the porous separator plate (6).

5. The method as claimed in one of the preceding claims, characterized in that the exchange of water between the cathode gas chamber and the cooling chamber is set by means of the pressure within the cathode gas chamber and/or cooling chamber.

6. The method as claimed in one of the preceding claims, characterized in that there is a metering device (10) for metering the cooling medium.

7. The method as claimed in one of the preceding claims, characterized in that there is a water separator (9) for humidification of the anode gas.

8. The method as claimed in claim 7, characterized in that the water separator (9) is designed as a membrane separator, the cooling medium being passed along one side of the membrane (16) and the dry anode gas being passed along the other side of the membrane.

9. The method as claimed in claim 7 or 8, characterized in that there is a circuit (8) for the anode gas, into which the electrochemical cell stack (1) and the membrane separator (9) for humidification of the anode gas are connected.

10. The method as claimed in claim 8 or 9, characterized in that there is a circuit (7) for the cooling medium, into which the cooling chamber (4) of the electrochemical cell stack (1), the membrane separator (9) and the metering device (10) for metering the cooling medium to the membrane separator (9) are connected.
